(19) United States
(12) Patent Application Publication
(10) Pub. No.: US 2020/0368769 A1
(43) Pub. Date: Nov. 26, 2020

(54) METHOD FOR SPRAYING INSULATING MIXED PAINT

(71) Applicant: WUYI UNIVERSITY, Jiangmen City (CN)

(72) Inventors: Baojian YANG, Jiangmen City (CN); Zhifeng GUAN, Jiangmen City (CN); Zhiqun HU, Jiangmen City (CN)

(21) Appl. No.: 16/991,911

(22) Filed: Aug. 12, 2020

Related U.S. Application Data
(63) Continuation of application No. PCT/CN2018/085038, filed on Apr. 28, 2018.

(30) Foreign Application Priority Data
Mar. 2, 2018 (CN) 201810174686.4

(51) Int. Cl. B05B 13/02; B05B 7/08; B05B 12/04; B05B 12/08

(52) U.S. Cl. CPC B05B 13/0278; B05B 7/0846; B05B 13/0228; B05B 12/082; B05B 12/04

(57) ABSTRACT

A method for spraying insulating mixed paint, which includes the following steps: (a) arranging two atomization nozzles at a spraying device with one of the atomization nozzles spraying a main paint mist and the other one of the atomization nozzles spraying a curing agent mist; (b) adjusting spray angles of the two atomization nozzles, such that the sprayed main paint mist and curing agent mist intersect at a spray area to form a paint mixing zone in which the main paint mist and the curing agent mist are mixed; (c) adjusting nozzle flow rates of the two atomization nozzles to control a mixing ratio of the main paint and the curing agent; and (d) placing a work piece in the paint mixing zone to spray the work piece.

### CROSS REFERENCE TO RELATED APPLICATIONS

This application is a continuation of International Application No. PCT/CN2018/085038, filed on Apr. 24, 2018, which takes priority from Chinese Patent Application No. 201810174686.4, filed on Mar. 2, 2018, the contents of each of which are incorporated by reference herein.

### TECHNICAL FIELD

This disclosure relates to paint spraying processes, and particularly relates to a method for spraying insulating mixed paint.

### BACKGROUND

A paint for spraying to form an insulating coating is made by mixing two insulating paints, a main paint and a curing agent, according to a certain proportion. Currently, a process of spraying the insulation coating is as follows: firstly, mixing the main paint and the curing agent according to a certain proportion with a mixer or other stirring devices, and then placing the mixed paint into a spraying device to spray a work piece. However, the paint formed by mixing the main paint and the curing agent solidifies fast, and thus is not easy to store. When the spraying pressure within a pipeline of the spraying device is not high enough, or when the spraying device stops spraying, the mixed paint remaining on the pipeline of the spraying device will gradually solidify and results in pipeline blockage, which not only wastes the paint, but also causes malfunction of the spraying device, thereby seriously affecting the spraying efficiency.

### SUMMARY

In order to overcome the shortcomings of the prior art, the present disclosure provides a method for spraying insulating mixed paint, which is convenient for spraying, avoids blockage in a pipeline of a spraying device, ensures normal operation of the spraying device, and saves the spraying cost.

The technical solution adopted by the present disclosure to solve the technical problem thereof is as follows.

A method for spraying insulating mixed paint, includes the following steps:
(a) arranging two atomization nozzles at a spraying device with one nozzle spraying a main paint mist and the other nozzle spraying a curing agent mist;
(b) adjusting spray angles of the two atomization nozzles, such that the sprayed main paint mist and curing agent mist intersect at a spray area to form a paint mixing zone in which the mixing of the main paint mist and the curing agent mist is completed;
(c) adjusting nozzle flow rates of the two atomization nozzles to control a mixing ratio of the main paint and the curing agent; and
(d) placing a work piece in the paint mixing zone to spray the work piece.

As an improvement of the above solution, a distance between the two atomization nozzles is 630-700 mm.

As a further improvement of the above solution, a distance from the work piece to a connecting line between the two atomization nozzles is 250-310 mm.

Further, an included angle between a central axis of each atomization nozzle and the connecting line between the two atomization nozzles is equal.

Further, the included angle between the central axis of each atomization nozzle and the connecting line between the two atomization nozzles is 30-50 degrees.

Further, in the spraying process, a plurality of work pieces pass through the paint mixing zone one by one, and the work pieces move in a direction parallel to the connecting line between the two atomization nozzles.

Further, the work pieces move at a speed of 32-38 mm/s.

Further, the work piece spins while passing through the paint mixing zone.

Further, the spin speed of the work piece is 30-90 r/min.

Further, the main paint is an epoxy resin insulating paint, and the curing agent is a polyamide paint.

Beneficial effects of the present solution are as follows: compared with the prior art, in the present disclosure, two atomization nozzles are arranged to spray the main paint and the curing agent respectively, and the mixing of the main paint and the curing agent is completed in the process of being sprayed to the surface of the work piece, thus eliminating the step of mixing and stirring the paint. Therefore, the time for mixing the paint is saved, the cost of spraying is saved, and the spraying efficiency is improved. Secondly, the main paint and the curing agent are sprayed by the two atomization nozzles, respectively, and will not contact each other before being sprayed out, so that the situation in which the main paint solidifies in the pipeline of the spraying device after being mixed with the curing agent and results in pipeline blockage will not occur, thereby ensuring the normal operation of the spraying device, reducing the maintenance cost of the spraying device, making full use of the paint, and reducing the waste of the paint.

### BRIEF DESCRIPTION OF THE DRAWINGS

The present solution will be described below in detail with reference to the accompanying drawings and embodiments.

FIG. 1 shows a schematic diagram of spraying of the present solution.

### DETAILED DESCRIPTION

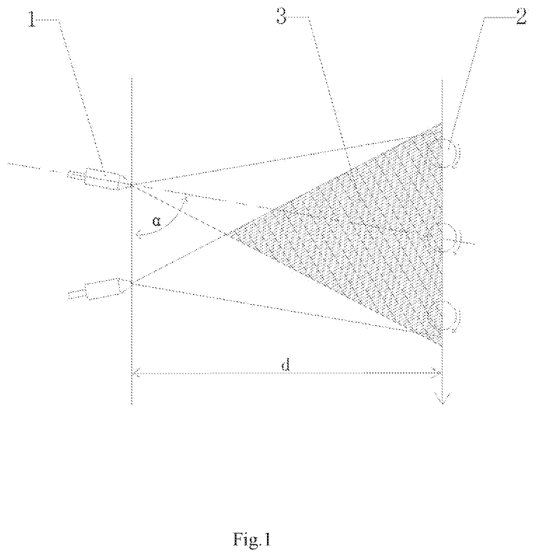

Referring to FIG. 1, a method for spraying insulating mixed paint includes the following steps:
(a) arranging two atomization nozzles 1 at a spraying device with one of the atomization nozzles 1 spraying a main paint mist and the other one of the atomization nozzles 1 spraying a curing agent mist;
(b) adjusting spray angles of the two atomization nozzles 1, such that the sprayed main paint mist and curing agent mist intersect at a spray area to form a paint mixing zone 3 in which the mixing of the main paint mist and the curing agent mist is completed;
(c) adjusting nozzle flow rates of the two atomization nozzles 1 to control a mixing ratio of the main paint and the curing agent; and
(d) placing a work piece 2 in the paint mixing zone 3 to spray the work piece.

There are various specifications and sizes of the two atomization nozzles 1 that can be selected for the spraying device. Table 1-1 shows spray parameters of several commonly used atomization nozzles. When the work piece 2 to be sprayed has a large area, a larger amount of the spray paint is needed, and the greater the area to be sprayed is, the larger the atomization nozzle 1 required is. The two atomization nozzles 1 of the same specification are adopted.

TABLE 1

| | | Spraying span of parallel pattern | | Air usage amount | Air |
|---|---|---|---|---|---|
| diameter φ, in | Spraying quantity | spraying and spraying width | | (during continuous | Compressor |
| mm | of water in ml/min | 200 mm | 300 mm | parallel pattern spraying) | in KW |
| 0.5 | 0-60 | 160 | 200 | 60 | 0.4-0.75 |
| 1.0 | 0-250 | 200 | 250 | 80 | 0.4-0.75 |
| 1.3 | 0-360 | 250 | 350 | 100 | 0.75-1.5 |
| 2.0 | 0-600 | 300 | 400 | 140 | 0.75-1.5 |

Table 1-1 shows spray parameters of commonly used atomization nozzles

Referring to FIG. 1, preferably, a distance between the two atomization nozzles 1 is 670 mm, a distance from the work piece 2 to a connecting line between the two atomization nozzles 1 (i.e., the distance din FIG. 1) is 280 mm, an included angle of a fan section sprayed by the atomization nozzles 1 is about 120 degrees, and an included angle between a central axis of each atomization nozzle 1 and the connecting line between the two atomization nozzles 1 is equal, so that the mixing effect of the main paint and the curing agent is optimized, and the mixing ratio of the main paint and the curing agent is easily adjusted. The mixing ratio of the main paint and the curing agent is controlled by controlling the nozzle flow rates of the atomization nozzles 1, i.e., by controlling a paint spraying speed of the atomization nozzles 1. For example, when the ratio of the main paint to the curing agent is 2:1, the paint spraying speed of the atomization nozzle 1 for spraying the main paint is twice that of the atomization nozzle 1 for spraying the curing agent. In order to mix the main paint and the curing agent more fully, the included angle between the central axis of the two atomization nozzles 1 and the connecting line between the two atomization nozzles 1 (i.e., the included angle α in FIG. 1) is 40 degrees, which maximizes the area of the paint mixing zone 3, and not only can achieve better mixing, but also maximizes the spraying area, thereby improving the spraying efficiency.

Referring to FIG. 1, preferably, in order to better implement the automatic spraying of the work piece 2, in the spraying process, a plurality of work pieces 2 pass through the paint mixing zone 3 one by one by adopting an automatic transportation line, and the work pieces 2 are positioned and supported by clamping with a support fixture. The work pieces 2 move in a direction parallel to the connecting line between the two atomization nozzles 1, and move at a speed of 36 mm/s.

Referring to FIG. 1, preferably, the work piece 2 spins at a speed of 60 r/min while passing through the paint mixing zone 3. The work piece 2 needs to be sprayed with the insulating paint is mostly a strong-power metal hand tool, and the whole surface of the metal tool needs to be sprayed for insulation, so the tool needs to spin in the spraying process to allow uniform spraying of the paint on the surface of the tool. When passing through the paint mixing zone 3, the support fixture rotates by a friction belt.

Preferably, the main paint is an epoxy resin insulating paint, and the curing agent is a polyamide paint.

Compared with the prior art, in the present solution two atomization nozzles 1 are adopted to spray the main paint and the curing agent, respectively, and the mixing of the main paint and the curing agent is completed in the process of being sprayed to the surface of the work piece 2, such that the step of mixing and stirring the paint is eliminated. Therefore, the time for mixing the paint is saved, the spraying cost is saved, and the spraying efficiency is improved. Secondly, the main paint and the curing agent are sprayed by the two atomization nozzles 1 respectively, and will not contact each other before spraying, so that the situation in which the main paint solidifies in the pipeline of the spraying device after being mixed with the curing agent and results in pipeline blockage will not occur, thereby ensuring the normal operation of the spraying device, reducing the maintenance cost of the spraying device, making full use of the paint, and reducing the waste of the paint.

The preferred embodiments of the present disclosure have been described in detail above with reference to the drawings. However, the present disclosure is not limited to the specific details in the above embodiments, various simple modifications can be made to the technical solutions of the present disclosure within the scope of the technical concept of the present disclosure, and these simple variations are all within the protection scope of the present disclosure.

It should be further noted that the specific technical features described in the above specific embodiments can be combined in any suitable manner without contradiction. In order to avoid unnecessary repetition, various possible combinations are not additionally illustrated in the present disclosure.

In addition, various different embodiments of the present disclosure can be randomly combined, and the combinations should also be regarded as the contents disclosed by the present disclosure as long as not deviating from the spirit of the present disclosure.

What is claimed is:

1. A method for spraying insulating mixed paint, comprising the following steps:
(a) arranging two atomization nozzles (1) at a spraying device with one of the atomization nozzles (1) spraying a main paint mist and the other one of the atomization nozzles (1) spraying a curing agent mist;
(b) adjusting spray angles of the two atomization nozzles (1), such that the sprayed main paint mist and curing agent mist intersect at a spray area to form a paint mixing zone (3) in which the main paint mist and the curing agent mist are mixed;
(c) adjusting nozzle flow rates of the two atomization nozzles (1) to control a mixing ratio of the main paint and the curing agent; and
(d) placing a work piece (2) in the paint mixing zone (3) to spray the work piece (2).

2. The method for spraying insulating mixed paint of claim 1, wherein a distance between the two atomization nozzles (1) is 630-700 mm.

3. The method for spraying insulating mixed paint of claim 2, wherein a distance from the work piece (2) to a connecting line between the two atomization nozzles (1) is 250-310 mm.

4. The method for spraying insulating mixed paint of claim 3, wherein an included angle between a central axis of each atomization nozzle (1) and the connecting line between the two atomization nozzles (1) is equal.

5. The method for spraying insulating mixed paint of claim 4, wherein the included angle between the central axis of each atomization nozzle (1) and the connecting line between the two atomization nozzles (1) is 30-50 degrees.

6. The method for spraying insulating mixed paint of claim 1, wherein during spraying, a plurality of work pieces (2) pass through the paint mixing zone (3) one by one, and the work pieces (2) move in a direction parallel to the connecting line between the two atomization nozzles (1).

7. The method for spraying insulating mixed paint of claim 6, wherein the work pieces (2) move at a speed of 32-38 mm/s.

8. The method for spraying insulating mixed paint of claim 6, wherein the work pieces (2) spin while passing through the paint mixing zone (3).

9. The method for spraying insulating mixed paint of claim 8, wherein the work pieces (2) spin at a speed of 30-90 r/min.

10. The method for spraying insulating mixed paint of claim 1, wherein the main paint is an epoxy resin insulating paint, and the curing agent is a polyamide paint.
